(19) United States
(12) Patent Application Publication
(10) Pub. No.: US 2009/0173142 A1
(43) Pub. Date: Jul. 9, 2009

(54) CONTROLLING GAS PRESSURE IN POROSITY STORAGE RESERVOIRS

(75) Inventors: Stanley R. Peters, Castle Rock, CO (US); Donald O. Summers, Morrison, CO (US)

Correspondence Address: MERCHANT & GOULD PC, P.O. BOX 2903, MINNEAPOLIS, MN, 55402-0903, US

(73) Assignee: PS Systems Inc., Lakewood, CO (US)

(21) Appl. No.: 12/349,297

(22) Filed: Jan. 6, 2009

Related U.S. Application Data
(63) Continuation-in-part of application No. 12/179,497, filed on Jul. 24, 2008, now abandoned.
(60) Provisional application No. 60/951,630, filed on Jul. 24, 2007.

(51) Int. Cl. G01N 15/08; E21B 49/00

(52) U.S. Cl. 73/38; 73/152.05

(57) ABSTRACT

A method and reservoirs are described that provide for controlling gas pressure within a porosity storage reservoir. In embodiments, gas is injected into the porosity storage reservoir while water is being extracted from the reservoir to provide greater efficiency in extracting the water from the reservoir. The gas may be injected at a predetermined target pressure or at a variable pressure. In other embodiments, a vacuum is applied to the reservoir while water is being injected into the reservoir to provide greater efficiency when introducing water into the reservoir.

### CROSS-REFERENCE TO RELATED APPLICATION

This application claims priority to U.S. Provisional Patent Application No. 60/951,630 entitled “INCREASED PUMPING PERFORMANCE USING AIR PRESSURE WITH UNDERGROUND WATER RESERVOIRS” filed Jul. 24, 2007, which is hereby incorporated by reference in its entirety as if set forth herein in full. This application is a continuation-in-part of prior application Ser. No. 12/179,497, filed Jul. 24, 2008, which application is hereby incorporated herein by reference.

### BACKGROUND

Porosity storage reservoirs are used for underground storage of water. A porosity storage reservoir uses porous materials such as alluvial materials (e.g., sand and gravel particles) to store water. The reservoir is created by using a barrier to separate the porous material from surrounding porous material. This separation requires a substantially water impermeable man-made barrier, for example a soil-bentonite slurry wall that is keyed into an underlying bedrock formation.

The net storage capacity of a porosity storage reservoir may be determined by first filling the reservoir to its ultimate storage capacity, often with water levels higher than those occurring naturally and then emptying the reservoir. The net storage capacity of the reservoir will depend on a number of factors including the characteristics of the porous material, e.g., the particle size distribution.

It is with respect to these and other background considerations, limitations and problems that the present invention has been developed.

### SUMMARY

Described are embodiments of methods and reservoirs that provide for controlling gas pressure within the headspace of a porosity storage reservoir. In embodiments, the present invention comprises injecting gas into the porosity storage reservoir while water is being extracted from the reservoir. Injecting gas into the reservoir provides greater efficiency in extracting the water from the reservoir. The gas may be injected at a predetermined target pressure or at a variable pressure. In other embodiments, the present invention provides for application of a vacuum to the reservoir while water is being introduced into the reservoir. The application of a vacuum provides greater efficiency when introducing water into the reservoir.

In other embodiments, the present invention provides a well for use in extracting and introducing water into a porosity storage reservoir. The well includes a well casing, filter pack material located around an outside surface of a first portion of the well casing, and a plug material located around the outside surface of a second portion of the well casing. The first portion of the well casing includes a number of perforations that allow water to flow into and out of the well casing. The second portion includes a number of fins that are surrounded by the plug material. The plug material creates a gas seal between the well casing and the native topsoil and reduces the amount of gas that enters or escapes the reservoir from around the well casing. In embodiments, the plug material includes dry bentonite.

This Summary is provided to summarize certain embodiments of the disclosed systems and methods that are further described below in the Detailed Description. This Summary is not intended to identify important or essential features, nor is it intended to be used to limit the scope of the claims.

### BRIEF DESCRIPTION OF THE DRAWINGS

FIG. 1 illustrates a sectional view of an embodiment of an gas distribution system in a porosity storage reservoir that provides for controlling gas pressure within a reservoir.

FIG. 2 illustrates a plan view of the embodiment of the porosity storage reservoir illustrated in FIG. 1.

FIG. 3 illustrates a graph showing differences in exemplary pumping rates, when pumping water from a porosity storage reservoir, between pressurized and unpressurized pumping.

FIG. 4 shows a sectional view of a porosity reservoir equipped with an embodiment of a headspace pressure management system.

FIG. 5a illustrates an embodiment of a porosity reservoir that utilizes an air blower to create a vacuum in the headspace of the reservoir during water injection.

FIG. 5b illustrates an embodiment of a porosity reservoir that utilizes an air blower to inject gas into the headspace of the reservoir during water extraction.

FIG. 6 illustrates an embodiment of a headspace pressure management system used in conjunction with a porosity storage reservoir.

FIG. 7 illustrates an embodiment of a pressure management method that may be utilized in a porosity storage reservoir such as those described above.

FIG. 8 illustrates a section view of a water well in accordance with an embodiment of the present invention.

FIG. 9 illustrates an embodiment of a component architecture for a headspace pressure management system.

### DETAILED DESCRIPTION

This disclosure describes systems and methods that improve injection and extraction rates and maximizes storage capacity of porosity storage reservoirs by controlling gas pressure within the reservoir. The gas pressure within the reservoir is controlled by at times injecting gas into the porosity storage reservoir such as while water is being extracted from the reservoir. Other times, a vacuum is applied to the reservoir such as when water is being introduced into the reservoir. The control of gas pressures within the porosity storage reservoirs allows for increased efficiency in extracting water from and injecting water into the reservoir resulting in greater storage capacity. It should be understood that although the description below describes the introduction of water into a reservoir as “injecting,” the water may be introduced into a reservoir by any means, including but not limited to filtration.

Porosity storage reservoirs are described in U.S. Pat. No. 6,840,710 hereby incorporated by reference in its entirety. U.S. Pat. No. 6,840,710 describes that porosity storage reservoirs include barriers that separate subsurface porous materials from adjacent subsurface materials. The barriers may be walls created using suitable materials such as a slurry, grout, concrete, sheet piles, plastic sheeting, rubber sheeting or combinations thereof, so long as they are substantially impermeable to water.

A porosity storage reservoir may be filled a number of ways including by placing water on the top of the reservoir and allowing gravity to move water from the top of the reservoir to the bottom of the reservoir. One method of filling a porosity storage reservoir is using pressurized water such as the direct injection methods described in U.S. Pat. No. 7,192,218 hereby incorporated by reference in its entirety. Water may be extracted from a porosity storage reservoir by pumping it from an extraction well.

It has been determined that, due to lateral constraints, detrimental air pressures (positive and negative) could occur during rapid filling and draining of the reservoir. Top-soil zones are often relatively impermeable to water and gas such as air, and thus if excessive gas pressure is allowed to build up under the top soil, such as in the porous materials of a porosity storage reservoir due to rapid injection of water, a separation of the top soil from the porous materials may lead to surface distress.

In embodiments of the methods and systems described herein, the substantial impermeability of some top soil zones to gases is used to control gas pressure in a reservoir. Increasing gas pressure within the reservoir assists in the extraction of water from the reservoir by reducing the work of pumps necessary to extract water. By applying a vacuum, the injection of water into the reservoir may also be assisted. The top soil zone will be unaffected as long as the gas pressure applied to the reservoir does not exceed a failure pressure at which the permeability of top soil zone begins to degrade/increase as the top soil is altered by the pressure differential between the porous storage media and the ambient pressure above the top soil. The gas pressure within the storage media can be varied as needed to assist in extraction/injection of the water from the reservoir, although it is preferable to operate the system so that the pressure in the storage media is less than the failure pressure.

The failure pressure of a top soil zone is anticipated to vary from site to site. The failure pressure may be empirically determined through testing under controlled conditions or may be assumed based the type and depth of top soil material, type and density of vegetation, soil moisture and other conditions that affect the cohesiveness of the top soil zone.

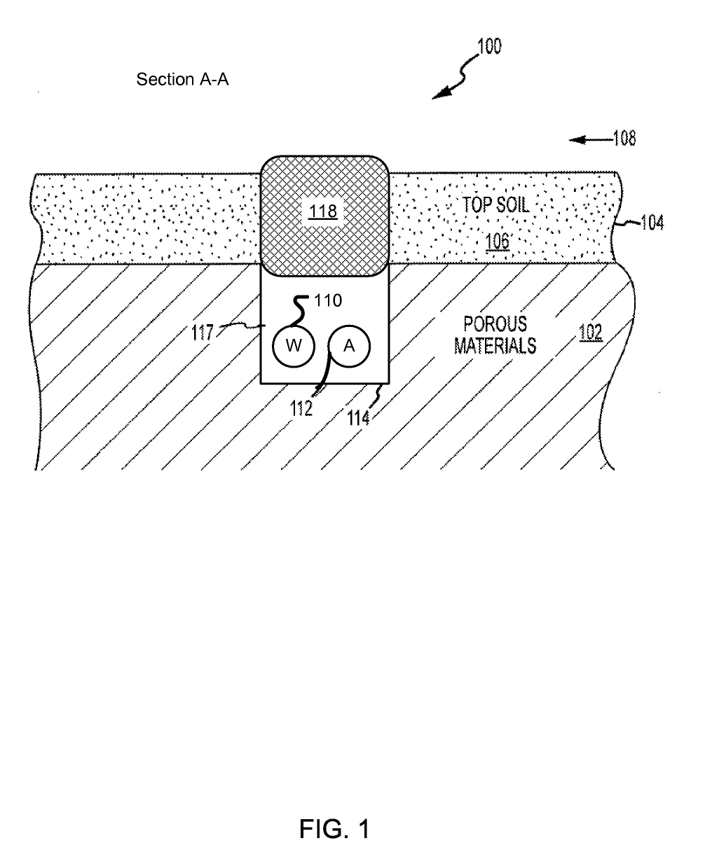

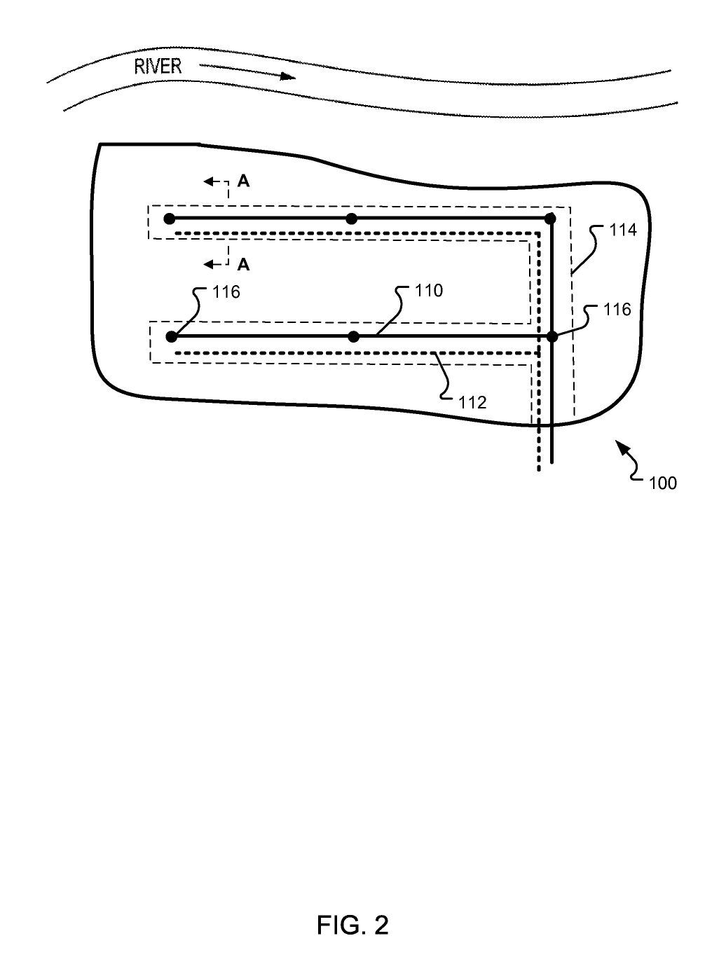

FIGS. 1 and 2 illustrate an embodiment of a pressure management system for use in porosity storage reservoir 100 that provides for controlling gas pressure within the reservoir 100. FIG. 1 illustrates a section view of a portion of the interior of a porosity storage reservoir 100, while FIG. 2 illustrates a plan view. The reservoir 100 includes a volume of subsurface porous material 102 within which water can be stored. A surface barrier 104 (which in FIG. 1 is made of top soil 106 but could be any impermeable or similarly impermeable material such as concrete or clay overburden) separates the storage material 102 from atmosphere 108. The barrier 104 can have a variety of thicknesses, which in a natural system may vary in depth and other properties throughout the site. For natural top soil barriers 104, it is anticipated that the top zone will have be from 2 to 10 feet thick.

In the embodiment shown, pressure management in the reservoir 100 is provided through the use of a trench 114 through which two conduits are provided, one 112 for air and one 110 for water. Through this system the pressure in the “headspace”, that is the unsaturated zone above the water level in the reservoir 100, can be controlled through the addition or removal of gas via the gas conduit 112. The remainder of the trench 114 may be filled with any suitable porous filter pack material or combinations of material 117 such as gravel, sand, rip rap, etc. At the surface, the trench 114 is further provided with some low permeability material 118 such as concrete, clay, bentonite, top soil or a combination of such materials. Preferably such a cap is approximately as impermeable or more impermeable than the barrier 104 although, if the surface area of the trench 114 is low, it may be possible to use a more permeable cap while still achieving improved operation of the reservoir 100.

Water conduit 110 transports water and may be used to inject water into volume 102. In the embodiment shown, water conduit 110 is in fluid communication with storage material 102 through a number of vertical wells 116 (see FIG. 2) that are used to inject water into subsurface storage volume. Water conduit 110 may be located at a predetermined depth below the surface to prevent freezing during winter. In an alternative embodiment, a water conduit 110 may not be provided in the trench 114. For example in an embodiment in which there is only one injection point or embodiments in which, for whatever reason, the water system is maintained at or above the surface.

Gas conduit 112 is also in fluid communication with volume 102. The gas conduit 112 comprises a number of perforations, not shown, along its length that allow gas to be transferred between the conduit 112 to storage volume 102 through the filter pack material 117. In one embodiment, gas conduit 112 is made of perforated PVC pipe, wrapped in a geo-textile fabric. In an embodiment, the gas conduit 112 may be in fluid communication with one or more vertical ventilation pipes (not shown) through which gas can be supplied or removed from the conduit network. Control devices, such as active or passive valves, may be incorporated into the gas conduit network. These devices can be used to control the flow of gas through conduit 112. For example, in a system optimized for increased injection rates passive check valves incorporated into vertical ventilation pipes connecting the gas conduit network to the atmosphere. The check valves may be incorporated so that during water injection when a vacuum is pulled through the gas conduit network the valves close allowing the pressure in the headspace above the water in the storage material 102 to be artificially reduced. Such passive check valves may be designed to only operate at pressure differentials greater than some threshold amount so that when water is being injected or extracted at a slow rate passive ventilation is provided. In an alternative embodiment, active control valves may be used to control venting to the atmosphere actively. As discussed elsewhere in this application, other active pressure control and pressure generating devices such as pumps, compressors, blowers and turbines may be used to create and control the flow of gas through conduit 112 and therefore the change the pressure in the headspace above the water level in the storage volume 102. The gas conduit network 112 may further include various manifolds and piping so that the gas flow generated by the pressure control and pressure generating devices can be distributed to the desired locations within the headspace of the reservoir.

The gas conduit network 112 provides a gas pressure control mechanism that allows changes in gas pressure during extraction or recharge of water from reservoir 100. In the pressure-controlled reservoir 100, the pressure change induced in the headspace by the injection of water into the reservoir 100 may be relieved through the active removal of gas via the gas conduit 112. In an embodiment, gas is extracted through the gas conduit 112 by drawing a vacuum (i.e., negative gas pressure), which increases the efficiency of injecting water into storage volume 102 by providing a suction force of a greater magnitude that would otherwise occur naturally or with the use of passive venting. During water extraction, the pressure management system allows the headspace to be pressurized so that the pumping efficiency of extracting water from the reservoir 100 is increased.

While FIG. 1 illustrates conduits 110 and 112 within the same trench 114, the present invention is not limited thereto. As those with skill in the art will appreciate, conduits 110, 112 may each have separate trenches 114 or the trenches may be omitted altogether in favor of surface piping and subsurface points of injection/extraction of gas and water. Likewise, the gas and water distribution networks need not be collocated and may be spaced apart from each other. In other embodiments, conduits 110 and 112 may have other configurations in relation to each other.

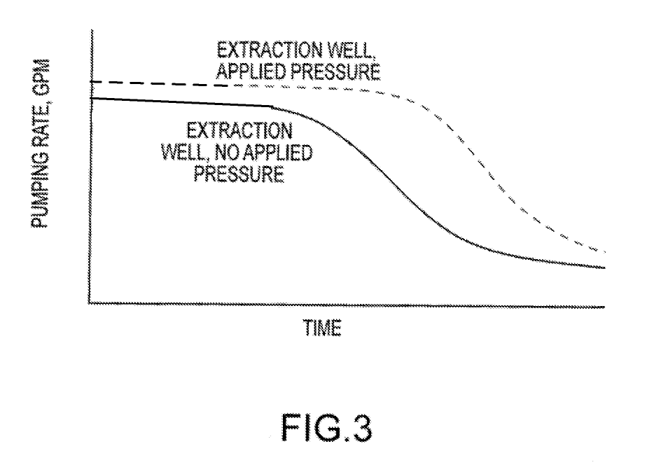

While the systems discussed with reference to FIGS. 1 and 2 provide improvements in reservoir operation and efficiency, FIG. 3 graphically illustrates the anticipated effect on pumping rates during extraction with and without the use of the technology described herein. When a higher pressure is applied to the headspace, the pumping rate (illustrated by the dotted line) is anticipated to be greater than the pumping rate that would occur without the added the pressurization of the headspace (solid line). Although not shown, the pumping rate during injection is anticipated to show the same effect when the injection is assisted by the active reduction of the pressure in the headspace.

As discussed above, the efficiency of extraction and injection of water into an underground porosity storage reservoir may be improved by controlling gas pressure within the headspace of the reservoir. Another aspect of the systems and methods disclosed herein is the selection of the gas or mixture of gases used to control pressure. In an embodiment, ambient air may be used when adding gas to the reservoir to increase pressure and the gas removed during water injection may be vented to the atmosphere. However, in other embodiments described herein, it may be desirable to avoid injecting certain gases, such as oxygen or carbon dioxide into volume 102. Some gases may react with materials within volume to create precipitates or products that contaminate the water stored in volume 102 or impair the operation of the extraction/injection equipment. Furthermore, some gases such as carbon dioxide and oxygen can create a more favorable environment for aerobic biological growth, which can foul the water stored in volume 102. Under other conditions, too little oxygen may cause the undesired growth of anaerobic bacteria. In these embodiments, the gas that is injected into volume 102 can be controlled to avoid these effects. For example, in embodiments, the gas can include an inert gas (such as helium, nitrogen, or argon) can be used. In other embodiments, the gas can be substantially free of oxygen.

It is presumed that ambient air may be the most cost effective gas to use as gas. If the negative effects of using air are tolerable it may be preferable to use air, as use of inert gases or special gas compositions may be expensive. As those with skill in the art will appreciate, the composition of gas can be controlled to suit specific situations. In yet another embodiment, the selection of the gas may change depending on the changing conditions of the reservoir 100.

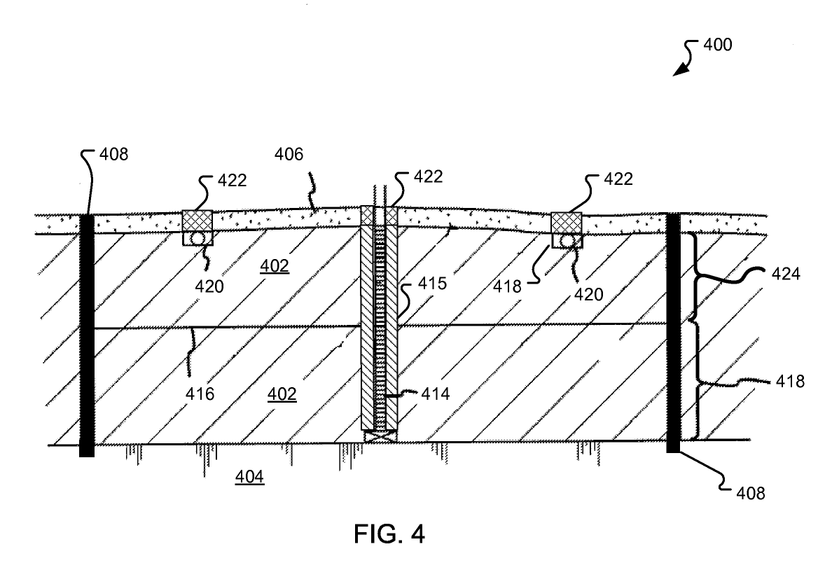

FIG. 4 shows a sectional view of porosity reservoir 400 equipped with an embodiment of a pressure management system. In the embodiment shown water may be injected into or extracted from the porous storage material volume 402 using a well. In an embodiment, the well includes a slotted pipe 414 surrounded by a gravel pack 415 within the storage material 402 and capped at the surface with a low permeability cap 422. The reservoir is bounded below by an aquiclude 404 such as bedrock, laterally by impermeable walls 408 such as slurry walls (which may be keyed into the bedrock 404 as shown), and above by a surface barrier 406 such as top soil or a concrete cap. The injection of water generates a saturated zone 418 and a headspace 424 above the water level 416 within the reservoir 400. As shown in FIG. 4, reservoir 400 includes an air conduit network 420 which are similar to air conduits 112 described above with respect to FIG. 1, contained within a trench 418 including a low permeability cap 422 at the surface. Conduit network 420 is in fluid communication with volume 402 and facilitates extracting gas from, and injecting gas into, volume 402.

Conduit network 420 is in fluid communication with a pressure supply system (not shown). Pressure supply systems are well known in the art and any suitable system, as necessary for the particular embodiment, may be used. For example, the pressure supply system may include one or more blowers, gas compressors or pressurized gas containers that may be reversible or piped in such a way as to provide reversible flow into and out of the conduit network 420.

In the embodiment shown, the gas conduit network 420 is illustrated near the surface of the adjacent to the surface barrier 404. In an alternative embodiment the gas conduit network 420 may be provided deeper in the volume 402.

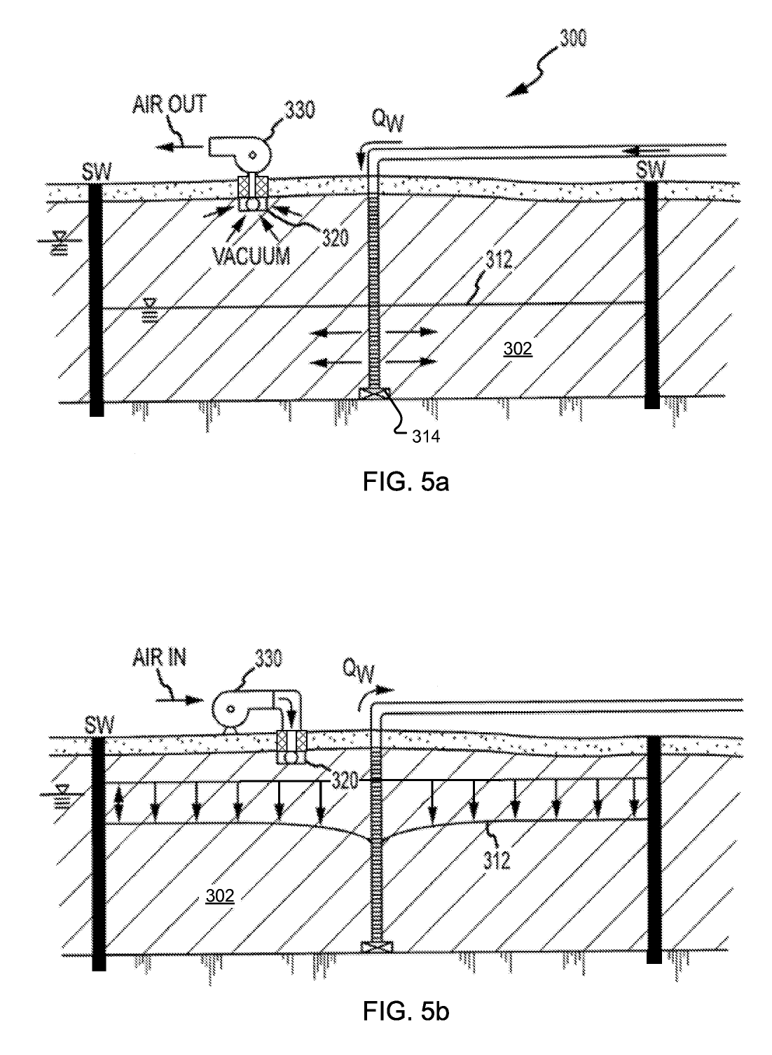

FIGS. 5a and 5b illustrate another embodiment of a pressure management system for a reservoir. FIG. 5a illustrates the operation during the injection of water into the reservoir 300 via well 314. During injection, a blower 330 is drawing gas from the headspace above the water level 312 via the gas conduit 320. As used herein, the blower 330 may be any type of device adapted to supply pressured gas now known or later developed.

FIG. 5b illustrates the operation during the extraction of water from the reservoir 300. During extraction, the water level 312 lowers as shown. At the same time, the blower 330 pushes gas into the headspace above the water level 312 thereby increasing the pressure in the headspace and adding extra driving force to the extraction of water.

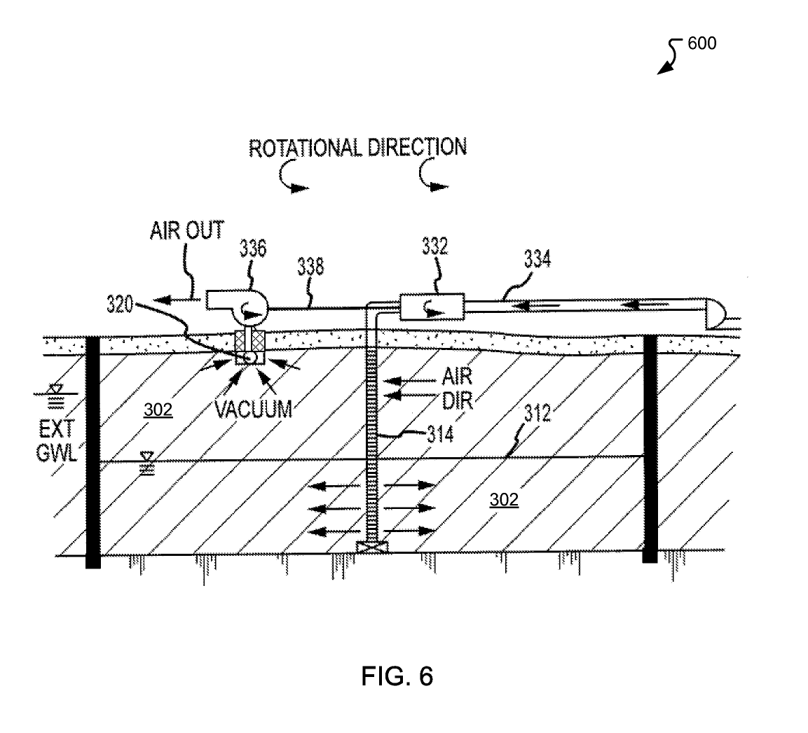

FIG. 6 illustrates another embodiment of a pressure management system used in conjunction with a porosity storage reservoir 500. FIG. 6 illustrates an in-line turbine 332 that is connected to a conduit 334. Water supply conduit 334 is fluidly connected to the well 314 and is used to transport water from the storage volume 302 during extraction and transport water to the volume 302 during injection. In one embodiment, in-line turbine 332 is coupled to a blower 336 through a shaft 338.

The water turbine 332, blower 336, and shaft 338 are configured so that when water is injected into the volume 302 through the conduit 334, the turbine 332 rotates and the blower 336 creates a vacuum that is applied to the volume 302. Also, when water is extracted from the volume 302, the blower 336 injects gas into the volume 302. In the porosity reservoir 300, water in conduit 334 rotates the in-line turbine 332, which in turn powers blower 336. The turbine 332 and blower 336 are mechanically coupled such that the blower automatically performs the appropriate action (injecting or extracting gas) at the appropriate level of effort for the direction and speed of water flow. In this way, the energy for the blower is extracted from the water flow.

An advantage of the dual-purpose, in-line water-air turbine system illustrated in FIG. 6 is that it is automatically activated by either injecting or extracting of water from volume 302. This eliminates the need for separate and independent gas and water equipment and related electronic control systems.

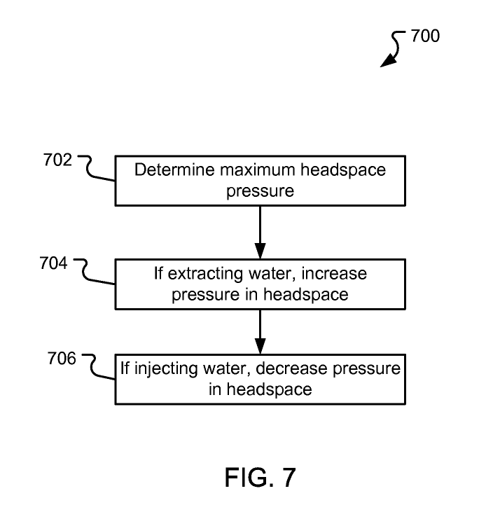

FIG. 7 illustrates an embodiment of a pressure management method 700 that may be utilized in a porosity storage reservoir such as those described above. Method 700 begins by characterizing the acceptable pressure differential between the headspace pressure and the atmospheric pressure in a characterization operation 702. As discussed above, this may include empirical testing of the site or test locations near the site of the reservoir. Alternatively, estimates may be used based on the depth of the surface barrier, material type, vegetation density, etc. In addition, a different pressure for extraction and injection operations may be determined. For example, it may be possible to have a higher pressure differential during water extraction than injection because of the additional support of the underlying porous storage material.

After characterizing the acceptable pressure, during extraction operations 704, the pressure in the headspace of the reservoir is increased by no more than the acceptable pressure. The pressure may be monitored during extraction operations 704 so that as the water is withdrawn the pressure in the headspace is maintained.

During injection operations 706, the pressure in the headspace is decreased by withdrawing gas from the headspace. The pressure may be decreased so as to achieve a target pressure differential based on the ambient pressure above the reservoir and this pressure may be maintained as the water is injected into the reservoir.

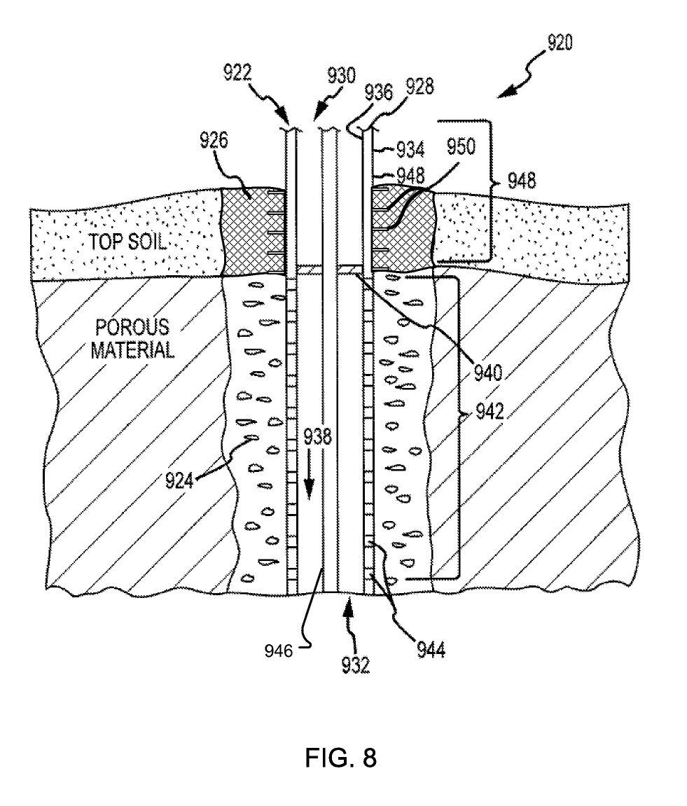

FIG. 8 illustrates a section view of a well 920 in accordance with an embodiment of the present invention. Well 920 includes a well pipe 946 surrounded by a well casing 922, filter pack material 924, and plug material 926. Well casing 922 includes a side wall 928 that extends from a top end 930 to a bottom end 932 of the well casing 922. The side wall defines an outer surface 934, an inner surface 936, and a channel 938. Well casing 922 also includes a perforated portion 942 that includes a plurality of perforations 944. The well casing 922 further includes an annular seal 940 that is disposed within channel 938 and is attached to inner surface 936 and well pipe 946. The annular seal 940 separates the perforated portion 942 of the casing 922 from an unperforated portion 948. A plurality of radial fins 950 are attached to the outer surface 934 near the top end 930 of well casing 922. In an embodiment, a submersible well pump (not shown) may be provided at or near the bottom of the well within the casing 922.

Well 920 provides improved performance compared to conventional wells and well casings when used in conjunction with a subsurface pressure management system. As one example, the annular seal 940 separates the unperforated portion 948 from the perforated portion 942 of casing 922. In the embodiment illustrated, the annular seal 940 is located at a level that coincides with the interface of a top soil barrier and the porous materials. However, the annular seal 940 may be located at any point in the unperforated portion 948. The seal 940 prevents gas pressure losses during emptying and reduced vacuum losses through the perforations 944 during filling.

Additionally, the combination of plug material 926 and radial fins 950, attached to the outer surface 934 provides, a substantially air tight seal around well casing 922. The plug material 926, in embodiments includes bentonite which promotes a substantial air tight seal between the top soil materials and the well casing 922. The plug material 926 prevents significant amounts of surface water from seeping down into the well hole as well as preventing easy air flow between the reservoir headspace and the atmosphere.

In an embodiment, the radial fins 950 are horizontal rings. Use of expanding plug material 926, such as plug mixtures containing bentonite and/or expansive grout, results in the expansive material swelling into the spaces between the radial fins 950 and the rough walls of the well excavation. In an embodiment, one, two, three, four or more (five are shown in FIG. 8) radial fins 950 may be used as needed so that the site of the well excavation does not become a source of pressure loss during operation.

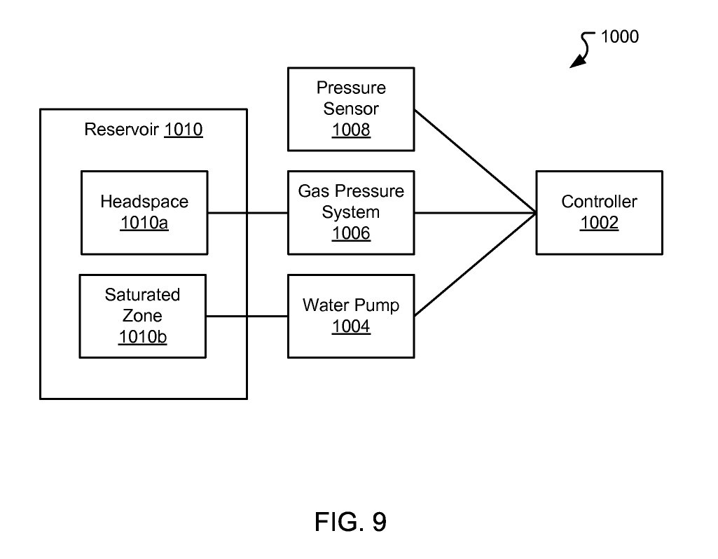

FIG. 9 illustrates an embodiment of a component architecture for a headspace pressure management system. In the embodiment illustrated, the headspace pressure management system 1000 includes a controller 1002, one or more water pumps 1004, one or more blowers 1006, and one or more pressure sensors 1008. As described above, these components work together so that as water is transferred into/out of the saturated zone 1010b of the reservoir 1010, gas is removed from/driven into the headspace 1010a of the reservoir 1010.

The one or more water pumps 1004 may be any type of water pump now known or later developed. Separate pumps 1004 may be provided for extraction and injection. Furthermore, the term “pump” as used herein refers to any device, equipment or construction that provides a force that moves water into or out of the reservoir 1010. For example, in an embodiment a water tank, water tower, open reservoir or other water storage device 1004 at a higher altitude than the porosity storage reservoir 1010 may be used to transfer water into the reservoir 1010, gravity being used in lieu of mechanical energy for water injection. For extraction, mechanical pumps 1004 may be provided. In one such embodiment, one or more wells may be provided with submersible, “down-hole” pumps under control of the controller 1002 for use in extraction of water.

The one or more blowers 1006 may be any type of device adapted to drive the flow of gas now known or later developed. Furthermore, the terms “blower”, “compressor” and “pressurization system” as used herein refers to any device, equipment or construction that provides a force that moves gas into or out of the reservoir 1010. As illustrated in FIG. 9, the term “gas pressure system” is used to remind the reader that the disclosure is not limited to specific equipment for managing the gas pressure in the headspace 1010a of the reservoir 1010. In an embodiment, separate blowers 1006 may be provided for increasing the pressure in the headspace 1010a and for decreasing (drawing a vacuum) in the headspace 1010a. Alternatively, the same blower or blowers 1006 may be used for both functions; the blower(s) being either reversible or, through alteration of the flow path capable of driving flow both into and out of the reservoir headspace 1010a. The blowers 1006 may be independently controlled by the controller 1002 or, as described above, may be mechanically connected to an in-line water turbine and thus controlled indirectly through the control of water flow through the water conduits.

The controller 1002 may be any equipment control device or set of devices now known or later developed. For example, in an embodiment the controller 1002 may be a general purpose computer running software applications that control the operation of the system 1000. Alternatively, the controller 1002 may be a purpose-built programmable logic controller (PLC) adapted specifically to control the pumps 1004, blowers 1006 and ancillary equipment such as valves, flow meters, etc. (not shown).

The system 1000 is further illustrated with pressure sensors 1008. These sensors may be located throughout the system 1000 including in conduit, in wells, and in the reservoir 1010 in either or both of the headspace 1010a and the saturated zone 1010b. Any type of pressure sensor or other monitoring device from which a measurement of gas and/or water pressure may be derived. The measurements of pressure obtained from the pressure sensors 1008 may be used to identify the current water level in the reservoir 1010 and/or to monitor the gas pressure in the headspace 1010a to allow the controller 1002 to operate the system 1000 to maintain the headspace 1010a at target pressures (e.g., a high pressure relative to ambient during water extraction and a low pressure during injection).

While a number of preferred embodiments have been described for purposes of this disclosure, various changes and modifications may be made which are well within the scope of the disclosed technology. For example, conduits 110 and 112 shown in FIG. 1 may be positioned at different depth and different orientations. As another example, barrier 104 shown in FIG. 1 may be made from materials other than top soil 106. Furthermore, numerous other changes may be made which will readily suggest themselves to those skilled in the art and which are encompassed within the scope of the technology.

We claim:

1. A method for controlling gas pressure in an underground porosity storage reservoir that comprises porous material, the method comprising:
introducing water into the underground porosity storage reservoir;
extracting water from the underground porosity storage reservoir; and
injecting or removing a gas at a predetermined location in the underground porosity storage reservoir to create positive or negative gas pressure that increases efficiency of filling and emptying operations of the underground porosity storage reservoir.

2. The method of claim 1 wherein gas in a headspace in the reservoir is maintained at a predetermined target pressure different than ambient atmospheric pressure during at least one of extracting water or introducing water.

3. The method of claim 2 wherein the target pressure is based on one or more of properties of a horizontal barrier that separates the porous material of the underground porosity storage reservoir from an atmosphere and properties of the porous material.

4. The method of claim 3 wherein the predetermined location in the underground porosity storage reservoir is in the headspace of the reservoir between the saturated zone and the horizontal barrier.

5. The method of claim 1 wherein the predetermined location in the underground porosity storage reservoir is near the top of the porous material.

6. The method of claim 1 further comprising:
while introducing water into the underground porosity storage reservoir, applying a vacuum to the predetermined location in the underground porosity storage reservoir.

7. The method of claim 2 further comprising:
determining the target pressure based on properties of the horizontal barrier.

8. The method of claim 2 further comprising:
determining the target pressure by applying different pressures to the headspace of the reservoir.

9. The method of claim 1 wherein the gas is substantially free of oxygen.

10. The method of claim 1 wherein the gas is selected from one or more of air, nitrogen, argon, helium.

11. An underground porosity storage reservoir comprising:
a volume of subsurface porous material separated from adjacent subsurface porous material by a first man-made barrier and separated from above-ground atmosphere by a second barrier;
a first conduit in fluid communication with the volume of subsurface porous material;
a well in fluid communication with the first conduit and in fluid communication with the volume of subsurface porous material, wherein the well is adapted to extract or inject water into the volume of subsurface porous material;
a second conduit in fluid communication with the volume of subsurface porous material; and
a control device for controlling a flow of gas through the second conduit into and out of a headspace in the volume of the reservoir.

12. The underground porosity storage reservoir of claim 11 further comprising:
one or more water first pumps adapted to pump water through the first conduit in response to direction from the control device.

13. The underground porosity storage reservoir of claim 11 wherein the control device comprises a valve in fluid communication with the second conduit, wherein when the valve is opened the volume of subsurface porous material is in fluid communication with above-ground atmosphere.

14. The underground porosity storage reservoir of claim 11 wherein the control device comprises a source of pressurized gas in fluid communication with the second conduit and the volume of subsurface porous material, the source of pressurized gas adapted to inject gas into and out of the volume of subsurface porous material.

15. The underground porosity storage reservoir of claim 11 wherein the second conduit comprises a perforated pipe.

16. The underground porosity storage reservoir of claim 15 wherein the second conduit is located adjacent to the second barrier in the volume of subsurface porous material.

17. The underground porosity storage reservoir of claim 11 wherein the first barrier comprises at least one of a slurry wall, a grout wall, or a concrete wall.

18. A well for use in an underground porosity storage reservoir, the well comprising:
a well pipe;
a well casing around the well pipe, the well casing comprising:
a side wall extending from a top end of the well casing to a bottom end of the well casing, the side wall defining an outer surface, an inner surface, and a channel containing the well pipe;
a plurality of perforations in a bottom portion of the side wall;
a plurality of fins attached to the outside surface near the top end of the side wall;
a annular seal disposed within the channel and attached to the inside surface;
filter pack material located around the outside surface of the perforated portion of the sidewall; and
plug material located around the outside surface near the top end of the side wall such that the plurality of fins are surrounded by the plug material.

19. The well of claim 18, wherein the plug material comprises bentonite.

20. The well of claim 18, wherein the annular seal separates the perforated portion and an unperforated portion of the side-wall.

21. An underground porosity storage reservoir comprising:
a volume of subsurface porous material separated from adjacent subsurface porous material by a first man-made barrier and separated from above-ground atmosphere by a second barrier;
a first conduit in fluid communication with the volume of subsurface porous material;
a second conduit in fluid communication with a headspace of the volume of subsurface porous material; and
an in-line water turbine adapted to extract energy from flowing water in the first conduit; and
a gas compressor adapted to drive a flow of gas in the second conduit, wherein the in-line water turbine is mechanically coupled to the gas compressor such that at least some of the energy extracted from the flowing water by the in-line water turbine drives the gas compressor.

22. The underground porosity storage reservoir of claim 21 further comprising:
at least one first pump adapted to pump water into the porosity storage reservoir via the first conduit, wherein pumping water into the porosity storage reservoir via the first conduit causes the in-line water turbine to rotate in a first direction thereby causing the gas compressor to remove gas from the headspace of the porosity storage reservoir via the second conduit.

23. The underground porosity storage reservoir of claim 21 further comprising:
at least one second pump adapted to pump water from the porosity storage reservoir via the first conduit, wherein pumping water from the porosity storage reservoir via the first conduit causes the in-line water turbine to rotate in a second direction thereby causing the gas compressor to inject gas into the headspace of the porosity storage reservoir via the second conduit.

24. The underground porosity storage reservoir of claim 23 wherein the at least one second pump adapted to pump water from the porosity storage reservoir via the first conduit includes a submersible well pump.
